(19) United States
(12) Patent Application Publication
(10) Pub. No.: US 2009/0275356 A1
(43) Pub. Date: Nov. 5, 2009

(54) Method of Controlling Interference

(75) Inventors: Thomas Malcolm Chapman, Southampton Hampshire (GB); Michael Farber, Wolfratshausen (DE)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Siemens Networks GmbH Co. KG

(21) Appl. No.: 12/225,617

(22) PCT Filed: Dec. 13, 2006
(86) PCT No.: PCT/GB2006/050450

§ 371 Date: Jun. 1, 2009

(30) Foreign Application Priority Data
Mar. 24, 2006 (GB) 0605809.3

(51) Int. Cl. H04B 7/00; H04L 27/28

(52) U.S. Cl. 455/522; 375/260

(57) ABSTRACT

A method of controlling interference between adjacent communication systems (1, 2) each of which operates in a predetermined frequency band. The method comprises reducing transmit power levels at frequencies (13, 14) at each end (10, 11) of the frequency band (12) and maintaining power levels at other frequencies (15) of the frequency bands (12), such that interference with frequencies at an end of the frequency band of an adjacent system is reduced.

This invention relates to a method of controlling interference between adjacent communication systems and for measurement during handover, in particular for use with the 3^{rd} generation partnership project (3GPP) universal mobile telecommunications system (UMTS) terrestrial radio access (UTRA) long term evolution (LTE).

Conventionally, operators have limited adjacent communications systems to being known types, whose adjacent band interference profiles are known and suitable sized guard bands were used to prevent overlap of emissions between systems. However, operators are becoming less careful with choice of adjacent system types, in order to maximise their own access to available spectrum. If, at the system design phase, the nature of systems designed in adjacent bands is not known, then the spectral power usage and guard bands need to be designed for the worst case scenario.

In accordance with a first aspect of the present invention, a method of controlling interference between adjacent communication systems, each communication system operating in a predetermined frequency band; comprises reducing transmit power levels at frequencies at each end of the frequency band and maintaining power levels at other frequencies of the frequency bands, such that interference with frequencies at an end of the frequency band of an adjacent system is reduced.

The transmit power from a transmitter in each cell to a mobile is reduced at the ends of the frequency band, so that there is less effect from stray transmissions interfering with another system in a adjacent frequency band. The profile and size of such reductions is done on a dynamic basis according to the actually deployed system, allowing guard bands to be reduced and allowing dynamic setting of the guard bands.

Preferably, reduction of transmit power levels is set on a per chunk, or per group of chunks basis.

In accordance with a second aspect of the present invention, a method of measurement during handover of a terminal between cells in a communication system, comprises taking power measurements for new and old cells; signalling from each cell a profile of transmit power levels and frequencies applicable to each of the power measurements; and modifying the power measurements according to the transmit power levels signalled at each frequency.

When a mobile device takes measurements to determine whether to stay in one cell, or to move to another cell, such as measuring common pilot channel (CPICH) receive signal code power (RSCP), the device assumes that the transmit power from the cell it is measuring is constant across the band. However, when the transmit power has been reduced at the edge of the band to reduce interference, the mobile device or network may make the wrong decision about moving because its assumptions are in error. To avoid such an error, in the present invention the network signals to the mobile information on the transmit power profile applied across its transmit band. This signalling enables the mobile device to correct its received measurements before deciding on a handover or reporting the measurement.

Preferably, the transmit power levels are set according to the method of the first aspect.

Preferably, the power measurements are measured from the common pilot channel.

Preferably, the systems comprise one of single carrier frequency division multiple access and orthogonal frequency division multiplex.

Preferably, the profile is signalled on one of a downlink common pilot channel a downlink synchronisation channel or a broadcast channel; or the profile is made available in neighbour cell lists.

An example of a method of controlling interference between adjacent communication systems and of measurement during handover of terminal between cells according to the present invention will now be described in which:

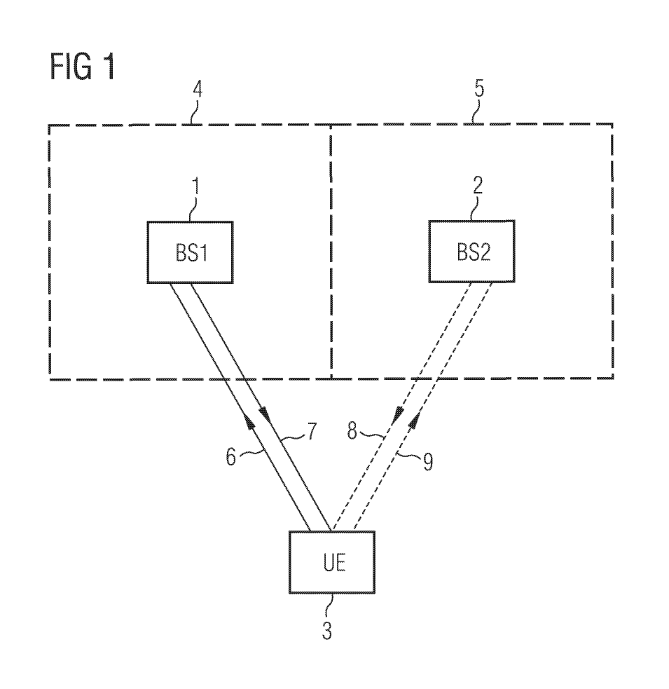

FIG. 1 is a block diagram illustrating a system for carrying out the method of the present invention;

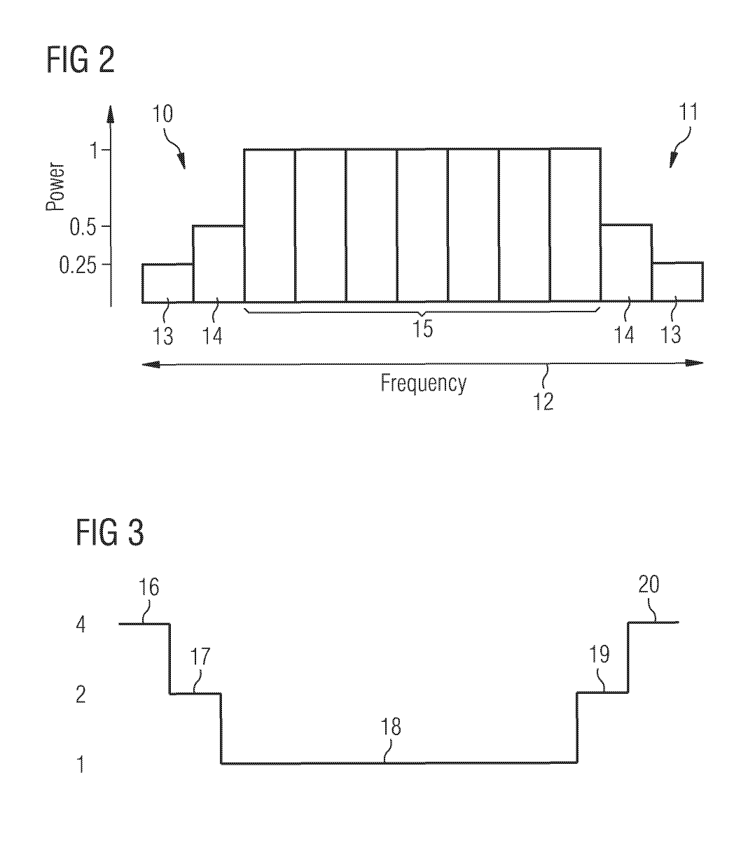

FIG. 2 is an example of a power against frequency profile for a cell, in the system of FIG. 1, whose power has been reduced at the band edges in accordance with the present invention; and,

FIG. 3 is an example of a mask applied by a mobile device in the system of FIG. 1, for making measurements during handover according to the present invention, where chunk specific power reduction values are set.

3GPP UTRA LTE is intended to be operated in spectrum allocations which are shared with other systems. Spectrum refarming for global system for mobile communication (GSM) will result in the coexistence of GSM and LTE in the same frequency band. The same may happen in UMTS coreband allocations, if no extension bands are available. Generally, mobile radio systems spectrum allocations are set up for systems that are designed with little, or no coordination between different system operators. The usual solution to the problems arising from the lack of coordination between operators is that sufficient guard bands are provided to avoid interference between systems, leading to the operator not being able to exploit their spectrum to the maximum extent.

Another feature of relevance to UTRA LTE, is that operators might wish to coordinate interference patterns between their cells in order to achieve a more optimal management of inter-cell interference and thus to improve air interface throughput and enhance user experience.

To ensure successful operation of the different systems, without coordination, scenario calculations are executed in the standards design phase, which take certain scenarios into account. This leads to the definition of radio frequency (RF) parameters, which allow uncoordinated system operation, but they introduce a penalty in the form of minimum system scenario requirements such as an assumed minimum coupling loss and a guard band. These parameters also act as constraints in implementing the system.

Although these parameters can be adapted to encourage operators towards a substantially similar system concept, leading to a minimum required guard band assuming the given system scenario, the situation gets more complex, if different system concepts are operated in close proximity and in the same band. A particular example of this being future operation of GSM and UMTS, or UMTS and LTE. Conventionally, the guard bands are set according to the worst case coexistence scenario. Thus, for many coexistence scenarios larger guard bands are required and there is a corresponding underutilisation of spectrum, which could otherwise be made available for commercial use.

Co-ordination of inter-cell interference by an operator is achieved by frequency re-use in GSM and is conventionally not possible with UTRA. For orthogonal frequency division multiplex (OFDM) systems, on option for co-ordination of interference between cells is to transmit certain orthogonal frequency division multiple access (OFDMA) tones with a lower power level than is used for others, where the subset of tones transmitted at lower power is co-ordinated between cells within the OFDMA system. An OFDM system might deliberately use less power on some tones, than on others.

FIG. 1 illustrates a typical system in which the method of the present invention can be applied. The system comprises two base stations 1, 2 in adjacent cells 4, 5. A mobile device, or UE 3 communicates with the base station 1 of the first cell 4. In order to reduce interference with other systems, or cells in the same band, the base station 1 in cell 4 modifies its transmissions by reducing the power of the transmissions at each edge 10, 11 of a frequency band 12, as shown in FIG. 2. Power reduction may be carried out on a regular sub-division of the frequency band, typically the unit of sub-division being a chunk, or resource unit 13 of the frequency band.

Thus, the example of FIG. 2 shows the 1st and 11^{th} chunks 13 and the 2^{nd} and 10^{th} chunks 14 are reduced in power to ¼ and ½ respectively of the power of the remaining chunks 15 to reduce the likelihood of stray emissions from these chunks interfering with neighbouring bands. The invention uses properties of the forthcoming LTE system in such a way that it is possible to minimize the provision of a guard band between systems. If, for example, the LTE downlink (DL) is chosen to be OFDMA and the uplink (UL) is chosen to be single carrier frequency division multiple access (SC_FDMA), then both are transmissions types with the property that the system bandwidth is divided into chunks, called resource units 13, 14, 15 as illustrated in FIG. 2, which can be treated independently in the radio resource.

Another feature of the LTE concept is that all data transmission is packet oriented, and a scheduler in a medium access control (MAC) can allocate protocol data units (PDU) to the resource units from time interval to time interval This allows a quite flexible and opportunistic allocation of user data to the radio resources. Conventionally, all resource units (chunks) have the same allowed maximum power, which varies according to cell size demanded in certain environments. A common pilot channel (CPICH) comprises pilot symbols set on position one of the time interval define the cell power and the pilots are needed so that mobile terminals can conduct measurements on the cell to decide whether or not to camp on a cell, whether to do neighbour cell measurements for handover and so forth.

The terminal measures the strength of the pilot channel and tries to work out which cell and frequency is best, based on average path loss across system bandwidth, which assumes all transmissions at the same power. Usually all tones from the cell need to be transmitted with maximum power, but in the present invention the frequency band allocated to an operator receives a power profile which lowers the maximum power stepwise, reduced as for chunks allocated closer to the band edge and being closer to the maximum for chunks at the centre of the band. Thus, with this variable power, a different indication of path loss is provided to indicate the power profile to the terminal. Furthermore, interference management techniques between cells of the same operator can also lead to variations in the maximum power within the band.

Any link budget losses caused by using reduced power are respected by the scheduler, i.e. the scheduler has knowledge of the impact on performance and schedules user data to chunks where performance is restricted for those cases where the user is close to a base transceiver station (BTS) or where the service has a low quality of service (QoS), such as for a background service. However, the CPICH pilots are also affected by this changed power profile, so a mobile device, or terminal measuring the CPICH receive s a reduced compound power of the pilots, and thus underestimates the received power.

FIG. 3 illustrates a mask applied by the terminal for making measurements on the cell, such as CPICH RSCP, if chunk specific power reduction values are sent. Thus, the mask requires the value measured in the first and last sections 16, 20 to be multiplied by 4 to get a correct result allowing for the reduced power at which these chunks had transmitted. In the next sections 17, 19 the received power is multiplied by 2 and in the central section 18, it is taken at face value. If this mask is sent over the broadcast channel, then it could be placed on that channel as correction factors (4,2,1,1,1,1,1,1,1,2,4). Alternatively, a single value of 1.29, representing the effect of the power profile, averaged across the band, could be broadcast.

CPICH measurements are typically made on the basis of mean pathloss between cells. If for some reason the cells have different power profiles and thus the underestimation of the power profiles differs, then the handover measurements do not give a true measurement of the pathloss situation. This is dealt with in the present invention by providing the mobile with a priori knowledge about the power profile. Defining a single power profile is somewhat inflexible because there may be no need for a power profile in one case, but multiple profiles with different slopes might be required in another situation. This will depend upon the nature of the systems which need to coexist. Thus, the present invention introduces a measure to identify the power slope setting for the terminal.

Information regarding the power slope setting can be broadcast by a broadcast channel (BCH), as an information element to the neighbour cell lists which are delivered to the MS to accelerate the measurements. Power profile information is added to the cell numbers in the neighbour cell information For an initial access to a system it may be a disadvantage to have to detect the BCH in order to identify the power profile setting of the cell. Thus, an alternative means of signalling the information is marking the profile in CPICH pilots. A CPICH in chunks without a power reduction is sent conventionally, whereas for chunks with power reduction a phase offset is applied to the CPICH and the phase offset increases with the power reduction. Alternatively, the synchronisation channel, which the UE uses in order to gain initial synchronisation, can be marked with information relating to the power profile. As a further alternative, rather than sending information relating to power reduction per chunk, a single correction factor applicable across all of the chunks is sent.

The present invention uses known power profile information obtained by a terminal making handover measurements in order to correct CPICH measurements in accordance with the power profile that has been used by the cell. This power profile is set such that the power is reduced near to the edges of the cell bands in order to reduce interference between operators. Power reduction per chunk is made known to the terminal and this can be done as the power reduction over groups of chunks, or all of the chunks. The power profile information may be transmitted to a terminal via the broadcast channel in a cell, or each cell can include information on neighbor cell power profiles in a neighbour cell list Alternatively, the power profile information is indicated by marking of the DL CPICH channel or by marking of the DL synchronisation channel The invention is particularly applicable to an OFDMA based system.

The power reduction of chunks at the band edges can be used between operators; or between transmission technologies, such as frequency division duplex FDD or time division duplex TDD; or between systems with different concepts, such as LTE and GSM to reduce the required guard bands. The scheduler in an all packet oriented system approach deals with the varying transmission quality of chunks, as long the scheduler has an a priori knowledge of the reduction in power. This reduction is delivered to the mobile station by the system information neighbour cell list, as additional information, and is also coded in the pilots by means of a phase rotation, or by the synchronisation channel which is marked with information relating to the power profile. The power profile can be transmitted as a map to the used chunks, or for signalling overhead reduction cases as an unique correction figure. This allows also corrected power measurements of idle mode LTE terminals.

The present invention also provides operational benefits in allocations which can be exclusively used for LTE, like UMTS extension bands, in that the band gaps between operators can be reduced and coexistence of LTE and frequency division duplex (FDD) is improved.

1. A method of controlling interference between adjacent communication systems, each communication system operating in a predetermined frequency band; the method comprising reducing transmit power levels at frequencies at each end of the frequency band and maintaining power levels at other frequencies of the frequency bands, such that interference with frequencies at an end of the frequency band of an adjacent system is reduced.

2. A method according to claim 1, wherein reduction of transmit power levels is set on a per chunk, or per group of chunks basis.

3. A method of measurement during handover of a terminal between cells in a communication system, the method comprising taking power measurements for new and old cells; signalling from each cell a profile of transmit power levels and frequencies applicable to each of the power measurements; and modifying the power measurements according to the transmit power levels signalled at each frequency.

4. A method according to claim 3, comprising setting the transmit power levels to control interference between adjacent communication systems, each communication system operating in a predetermined frequency band, the method comprising reducing transmit power levels at frequencies at each end of the frequency band and maintaining power levels at other frequencies of the frequency bands, such that interference with frequencies at an end of the frequency band of an adjacent system is reduced.

5. A method according to claim 3, comprising measuring the power measurements from the common pilot channel.

6. A method according to claim 1, wherein the systems comprise one of single carrier frequency division multiple access and orthogonal frequency division multiplex access.

7. A method according to claim 3, comprising signalling the profile on one of a downlink common pilot channel, a downlink synchronisation channel and a broadcast channel.

8. A method according to claim 3, wherein the profile is made available in neighbour cell lists.

9. A method according to claim 3, wherein the systems comprise one of single carrier frequency division multiple access and orthogonal frequency division multiplex access.

10. An apparatus for controlling interference between adjacent communication systems, each communication system operating in a predetermined frequency band; the apparatus comprising an apparatus configured to reduce transmit power levels at frequencies at each end of the frequency band and to maintain power levels at other frequencies of the frequency bands, such that interference with frequencies at an end of the frequency band of an adjacent system is reduced.

11. The apparatus according to claim 10, configured to set the reduction of transmit power levels on a per chunk, or per group of chunks basis.

12. The apparatus according to claim 10, configured to control access systems that are based on one of single carrier frequency division multiple access and orthogonal frequency division multiplex access.

13. An apparatus for providing measurement during handover of a terminal between cells in a communication system, the apparatus comprising an apparatus configured to take power measurements for new and old cells; to process signalling from each cell a profile of transmit power levels and frequencies applicable to each of the power measurements; and to modify the power measurements according to the transmit power levels signalled at each frequency.

14. The apparatus according to claim 13, further configured to set the transmit power levels to control interference between adjacent communication systems, each communication system operating in a predetermined frequency band by reducing transmit power levels at frequencies at each end of the frequency band and by maintaining power levels at other frequencies of the frequency bands, such that interference with frequencies at an end of the frequency band of an adjacent system is reduced.

15. The apparatus according to claim 13, configured to measure the power measurements from the common pilot channel.

16. The apparatus according to claim 13, configured to control access systems that are based on one of single carrier frequency division multiple access and orthogonal frequency division multiplex access.

17. The apparatus according to claim 13, configured to signal the profile on one of a downlink common pilot channel, a downlink synchronisation channel and a broadcast channel.

18. The apparatus according to claim 13, configured to make the profile available in neighbour cell lists.

19. The apparatus according to claim 9, comprising a mobile station configured to modify power measurements based on power profile information.
